(19) United States
(12) Patent Application Publication
(10) Pub. No.: US 2007/0286542 A1
(43) Pub. Date: Dec. 13, 2007

(54) Two cavity grease sealing system

(76) Inventor: Matthew T. Bober, Metamora, IL (US)

Correspondence Address: Kathleen K. Bowen Co.LPA, 311 Hillbrook Dr., Cuyahoga Falls, OH, 44223, US

(21) Appl. No.: 11/805,393

(22) Filed: May 23, 2007

Related U.S. Application Data
(60) Provisional application No. 60/808,016, filed on May 24, 2006.

(51) Int. Cl. F16C 33/76

(52) U.S. Cl. 384/485

(57) ABSTRACT

A grease sealing system for a wheel bearing system having a bearing housing and a wheel bearing housed therein. The grease sealing system is comprised of a sealing ring having an inner surface and an outer surface, wherein the inner surface faces the wheel bearing, and the outer surface faces away from the wheel bearing. The grease sealing system further has a main body, a primary sealing lip, and a secondary sealing lip, wherein the primary sealing lip, the sealing ring main body, and the wheel bearing system form a primary grease cavity, and the secondary sealing lip, the primary sealing lip, and the wheel bearing system form a secondary grease cavity. The grease sealing system further has a retaining ring located adjacent to the sealing ring outer surface, wherein the retaining ring has an inner diameter and an outer diameter, wherein the outer diameter is seated in the bearing housing.

This application claims the benefit of U.S. Provisional Application No. 60/808,016, filed May 24, 2006.

### BACKGROUND

The present invention is in the field of aircraft braking systems. More specifically this invention relates to grease seals around wheel bearings. Aircraft braking systems have grease around the bearings to help improve functionality. This grease is contained in a grease cavity around the bearings. The grease is contained around the bearings by a grease seal. This seal helps keep the grease in, and helps keep contaminants out of the bearing.

Typical grease sealing systems rely on a single grease seal lip, and the grease contained therein to prevent contaminant ingress to the bearing. This system has been shown to be vulnerable to situations such as high pressure water spray from cleaning procedures or wet runways.

Further, current systems provide rely on a single dynamic lip to prevent excessive grease loss. During the first high speed landing of the wheel, grease from a fully packed bearing will egress past the dynamic sealing lip. Further, once the grease escapes past the sealing lip, there is nothing to prevent this grease from escaping past the retaining ring, and onto the wheel during subsequent landings. Thus, once the grease has escaped past the sealing lip, it becomes useless, and a potential contaminant to other components of aircraft brake systems, such as the wheel and brake lining.

A grease sealing system is desired which would make it more difficult for contaminants to enter the bearing. Also a grease sealing system is desired which would better prevent grease egress, and which would make use of any grease which does egress.

### SUMMARY

A grease sealing system for a wheel bearing system having a bearing housing and a wheel bearing housed therein. The grease sealing system is comprised of a sealing ring having an inner surface and an outer surface, wherein the inner surface faces the wheel bearing, and the outer surface faces away from the wheel bearing. The grease sealing system further has a main body, a primary sealing lip, and a secondary sealing lip, wherein the primary sealing lip, the sealing ring main body, and the wheel bearing system form a primary grease cavity, and the secondary sealing lip, the primary sealing lip, and the wheel bearing system form a secondary grease cavity. The grease sealing system further has a retaining ring located adjacent to the sealing ring outer surface, wherein the retaining ring has an inner diameter and an outer diameter, wherein the outer diameter is seated in the bearing housing.

### BRIEF DESCRIPTION OF DRAWINGS

FIG. 1 is a cross sectional view of a wheel bearing assembly taken from FIG. 2.

FIG. 2 is an end view of a prior art wheel bearing assembly.

FIG. 3 is a cross sectional view of a wheel bearing assembly taken from FIG. 4.

FIG. 4 is an end view of a wheel bearing assembly according to an aspect of the invention.

FIG. 5 is an end view of a sealing ring according to an aspect of the invention.

FIG. 6 is a cross sectional view of a sealing ring taken from FIG. 5.

### DETAILED DESCRIPTION

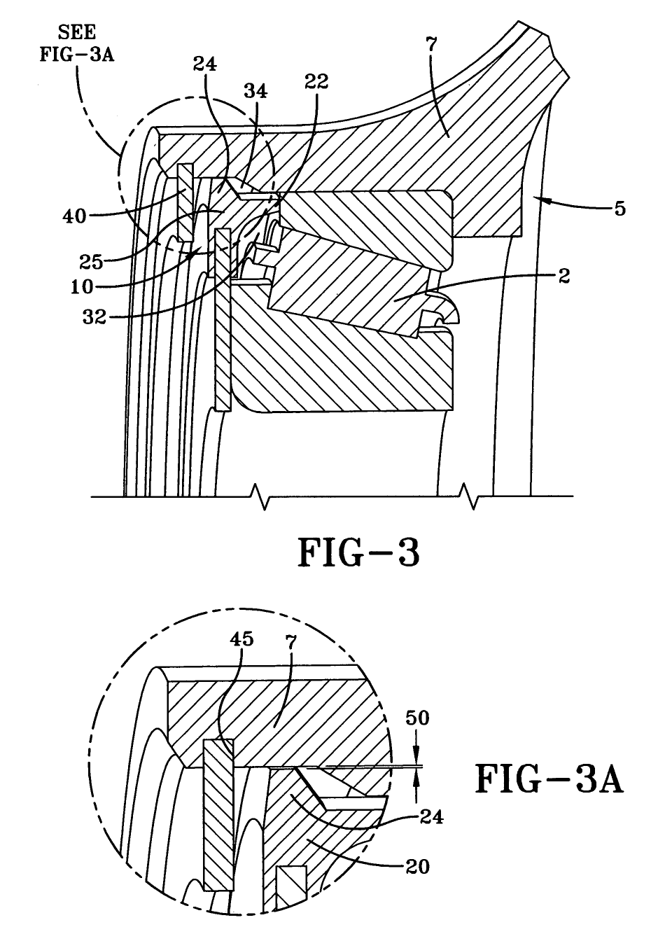

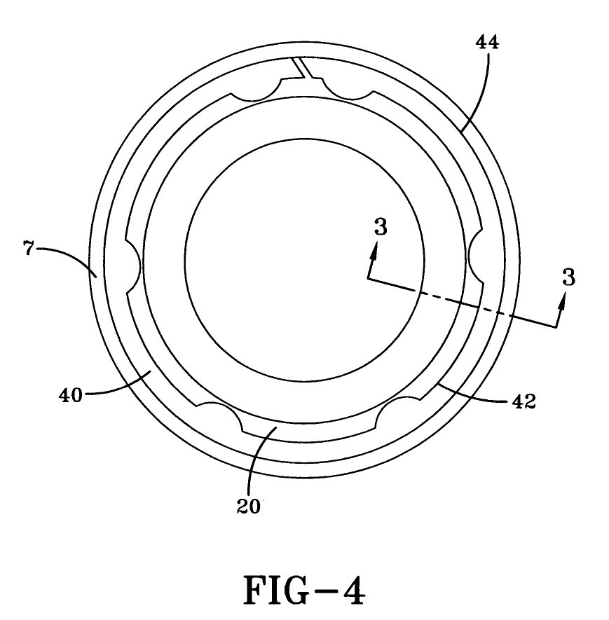

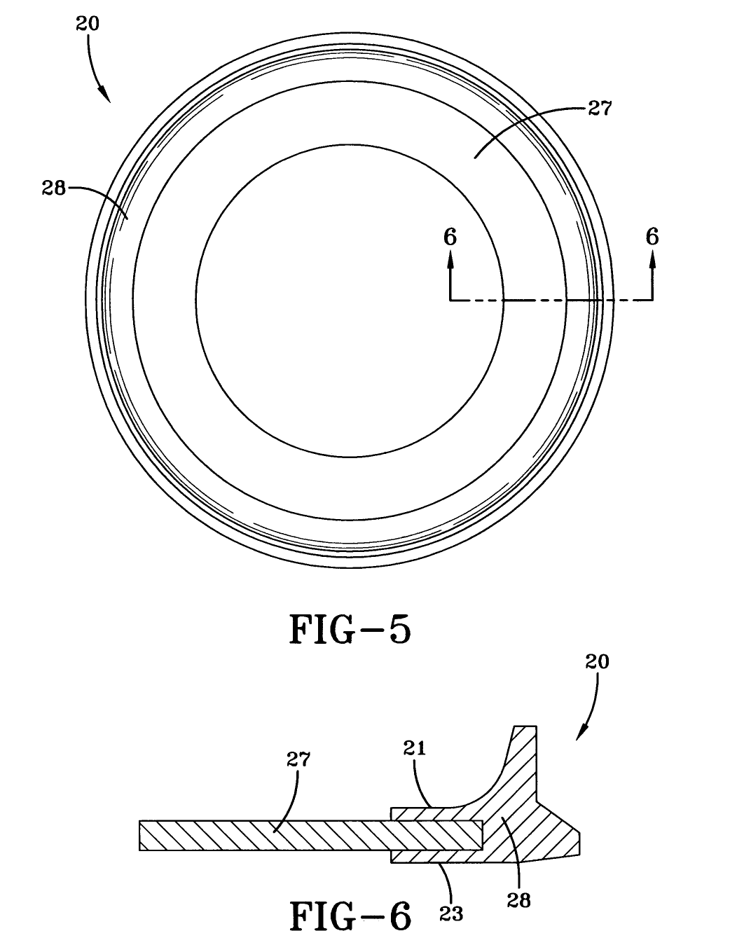

Various aspects of the invention are presented in FIGS. 3-6 which are not drawn to scale and in which like components are numbered alike.

Referring now to FIGS. 3-6, according to an aspect of the invention, a grease sealing system 10 for a wheel bearing system 5 is shown. The wheel bearing system 5 has a bearing housing 7 with a wheel bearing 2 housed therein. The grease sealing system 10 comprises a sealing ring 20, which forms two grease cavities, (a primary grease sealing cavity 32, and a secondary grease sealing cavity 34), with the wheel bearing system 5, and a retaining ring 40.

The sealing ring 20 has an inner surface 21 and an outer surface 23, wherein the inner surface 21 faces wheel bearing 2, and the outer surface 23 faces away from the wheel bearing 2. The sealing ring 20 further has a main body 25, a primary sealing lip 22, and a secondary sealing lip 24. The sealing ring 20 is typically a combination of a rigid inner ring 27 and a resilient outer ring 28. The resilient outer ring 28 is where the sealing lips 22 and 24 are located. The primary sealing lip 22, together with the sealing ring main body 25, rigid inner ring 27, and the wheel bearing system 5 form the primary grease cavity 32. The secondary sealing lip 24, together with the primary sealing lip 22, and the wheel bearing system 5 form the secondary grease cavity 34.

The extra cavity provides a second cavity for grease to flow. Thus, when grease escapes the primary grease cavity 32, such as during the first high speed spin-up, it will collect in the secondary cavity 34. This accumulated grease will act as another blockade to prevent contaminant ingress. As an additional benefit, the grease in the secondary cavity 34 makes it more difficult for additional grease to continue migrating past the primary sealing lip 22.

The retaining ring 40 is located adjacent to the sealing ring outer surface 23, and has an inner diameter 42 and an outer diameter 44, wherein the outer diameter 44 is seated in a complimentary groove 45 in the bearing housing 7. A primary purpose of the retaining ring is to maintain the seal and bearing assembly in the wheel before installation. After installation this function is conceded to the axle.

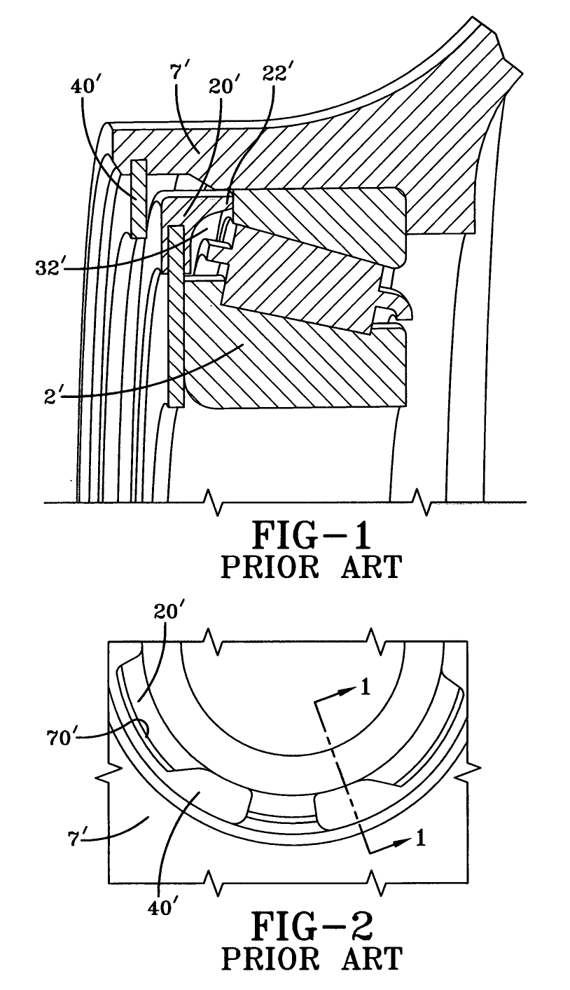

FIG. 1 is a cross section of a prior art grease seal. The grease cavity 32′ contained the grease per the sealing lip 22′ and the wheel bearing 2′. On the first high speed spin-out, the grease would leak past the sealing lip 22′, it would then proceed to leak past the retaining ring 40′, and out into the wheel, because there was nothing to stop it. FIG. 2 shows an end view of a prior art grease seal. This shows a gap 70′ which existed between the sealing ring 20′ and the bearing housing 7′, which the previous retaining ring 40′ exposed. This is a direct path for contaminants which has been eliminated with the present invention.

According to a further aspect of the invention, the primary sealing lip 22 seats on the wheel bearing 2, and the secondary sealing lip 24 seats on the bearing housing 7.

In a further embodiment of the invention there is a minimal clearance 50 between the secondary sealing lip 24 and the bearing housing 7.

In a preferred embodiment of the invention, the retaining ring inner diameter 42 is such that the retaining ring 40 completely covers the sealing ring secondary sealing lip 24. This allows the retaining ring 40 to act as a shield in such conditions as a direct water spray.

The retaining ring 40 sized in this way, combined with the secondary sealing lip 24 creates an external labyrinth, such that it becomes much more difficult for any contaminants to enter the bearing system.

According to another aspect of the invention, a grease sealing system is improved by providing a secondary grease cavity 34. A sealing ring 20 further comprises a secondary sealing lip 24, wherein the secondary grease cavity 32 is formed by the primary sealing lip 22, the secondary sealing lip 24 and the wheel bearing system 5. In a further embodiment of the invention, the grease sealing system 10 is further improved by incorporating the retaining ring 40 into the grease sealing system 10 by reducing the retaining ring inner diameter 42 such that the retaining ring 40 completely covers the secondary sealing lip 24.

We claim:

1. A grease sealing system for a wheel bearing system having a bearing housing and a wheel bearing housed therein, comprising:
a sealing ring having an inner surface and an outer surface, wherein said inner surface faces said wheel bearing, and said outer surface faces away from said wheel bearing, and further having a main body, a primary sealing lip, and a secondary sealing lip, wherein said primary sealing lip, said sealing ring main body, and said wheel bearing system form a primary grease cavity, and said secondary sealing lip, said primary sealing lip, and said wheel bearing system form a secondary grease cavity; and,
a retaining ring located adjacent to said sealing ring outer surface, wherein said retaining ring has an inner diameter and an outer diameter, wherein said outer diameter is seated in said bearing housing.

2. The grease sealing system of claim 1 wherein said primary sealing lip seats on the wheel bearing, and said secondary sealing lip seats on the bearing housing.

3. The grease sealing system of claim 2 wherein there is a minimal clearance between said secondary sealing lip and the bearing housing.

4. The grease sealing system of claim 1 wherein said retaining ring inner diameter is such that said retaining ring completely covers said sealing ring secondary sealing lip.

5. In a grease sealing system for a wheel bearing system having a bearing housing and a wheel bearing housed therein, and a retaining ring having an inner diameter and an outer diameter, wherein said outer diameter is seated in the bearing housing, wherein the grease sealing system has a sealing ring having an inner surface and an outer surface, wherein said inner surface faces said wheel bearing, and said outer surface faces away from said wheel bearing, wherein said retaining ring is adjacent to said sealing ring outer surface, wherein said sealing ring further has a main body and a primary sealing lip, wherein said primary sealing lip seats against the wheel bearing forming a primary grease cavity between said sealing ring main body, said sealing ring primary sealing lip, and the wheel bearing, the improvement comprising:
a secondary grease cavity, wherein said sealing ring further comprises a secondary sealing lip, wherein said secondary grease cavity is formed by said primary sealing lip, said secondary sealing lip and said wheel bearing system.

6. The grease sealing system of claim 5 wherein said secondary grease cavity is formed by said primary sealing lip, said secondary sealing lip and said bearing housing.

7. The grease sealing system of claim 6 wherein there is a minimal clearance between said secondary sealing lip and the bearing housing.

8. The grease sealing system of claim 6 wherein said secondary sealing lip is in sealing contact with the bearing housing.

9. The grease sealing system of claim 5 wherein the improvement further comprises incorporating said retaining ring into said grease sealing system by reducing said retaining ring inner diameter such that said retaining ring completely covers said secondary sealing lip.
